(19) United States
(12) Patent Application Publication
(10) Pub. No.: US 2011/0041446 A1
(43) Pub. Date: Feb. 24, 2011

(54) Shingle and Method of Using the Shingle

(76) Inventors: James Stephens, Sidney, OH (US); Gaylen Blosser, Greenville, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/990,458

(22) PCT Filed: Apr. 29, 2009
(86) PCT No.: PCT/US09/42142

§ 371 Date: Oct. 29, 2010

Related U.S. Application Data
(63) Continuation of application No. 12/112,043, filed on Apr. 30, 2008, now abandoned.

(51) Int. Cl. E04D 1/06; B05D 5/10

(52) U.S. Cl. 52/556; 427/207.1; 427/208.4; 52/746.11

(57) ABSTRACT

A shingle and a method of roofing using a plurality of the shingles. The shingle comprises an upper surface comprising an attachment area and an exposed area having a coating and an inking. The attachment area is in a plane lower than a plane of the exposed area and extends longitudinally along a top of the exposed area and horizontally along a side of the exposed area. The shingle comprises a bottom surface opposite the upper surface and an adhesive layer applied to a length of the attachment area adjacent to the exposed area. The shingles are attached to each other by the adhesive layer.

### FIELD OF THE INVENTION

The present invention relates generally to shingles used for covering a structure, and more particularly to shingles affixed to each other using an least an adhesive. Even more particularly, the invention relates to shingles having the look of traditional asphalt, slate, wood, standing seam, or tile shingles that are interconnected to each other using a high bond adhesive to form a waterproof covering.

### BACKGROUND OF THE INVENTION

Shingles for roofing are well known. The most common shingle materials are made from asphalt, wood, slate and clay tile. Roofing systems may also be made from rubber, plastics, fiberglass, and metals. Existing roofing systems typically comprise overlapping or interlocked members that are nailed to a substrate. Traditional shingles, while having certain advantages, also have disadvantages, such as a limited life, excessive weight, easily damaged or prone to decay, flammability, and difficulty in disposal or recycling. None of the traditional shingle materials last long-term. Clay and slate are heavy and usually require additional structural support. Snow and ice can build up on traditional shingles.

Wood shingles have particular disadvantages in that they easily dry in heat and sunlight. As wooden shingles dry, they lift and curl and become more susceptible to wind damage. Wood shingles are a fire hazard. Wood shingles are also prone to rot and must be replaced after about twenty years.

Asphalt shingles are used on about 85% of residential roofs in the United States. The asphalt used in shingles is made from petroleum, a non-renewable resource. Asphalt shingles are also dried by heat and ultraviolet sun rays. Asphalt shingles delaminate, lift, and retain heat, making the structure, such as a house, hotter in the summer. Asphalt shingles have a typical lifespan 20 years, when the roof must be replaced. Discarded asphalt shingles create more problems. According to the National Association of Homebuilders Research Center, 20 billion pounds of asphalt shingles are transported to landfills in the United States each year.

Metal roofing is an existing solution to some of the disadvantages of other types of roofing materials. Existing metal roofing provides a much longer roof life than asphalt shingles or wooden shingles—a typical metal roof can last up to 50 to 75 years—or even longer. Metal roofing is also less likely to be damaged or degrade. Metal roofing is much lighter than asphalt, tile, slate or wooden shingles. An advantage of metal roofing is that it can be installed over an existing asphalt shingle roof without removing the shingles. Metal roofs are also superior to wood or asphalt shingles in that they do not easily ignite. Metal roofs, including those that are light-colored or treated with “cool” coatings, deflect ultraviolet radiation, reducing the need for energy to cool the structure. Further, metal roofing is recyclable.

However, typical metal roofs present a very different look from asphalt, tile, slate or wooden shingles. Typical metal roofs, such as a standing seam roof, are made in standard lengths or rolls that are 28 inches wide with side seams formed at the factory. When applied, the panels overlap to provide a waterproof covering. The edge of one panel overlaps the edge the abutting panel. Untreated metal roofs were originally painted after installation to forestall rusting. Only a few colors were available, while asphalt offered a wide varieties of colors. Currently, deed restrictions or social pressure in many neighborhoods deter many consumers from metal as a roofing choice, even with the advantages of lower costs and a longer life.

In response to a desire to conform with the look of asphalt or wooden shingles, metal shingles have been developed. Originally, tin and terne plates, which are folded on the sides, were used. Soldering was needed on flatter roofs. Raised ornamentation was used to add stiffness to thin metal and the shingles were painted to decrease heat buildup and prevent rust.

In response to the need for improvements in metal roofing, newer metal shingles are typically individual plates that are stamped to create an interlock that couples with surrounding shingles. Some existing metal shingles have an overlap for a segment to be nailed to the roof structure and may include adaptations, such as crimping, that are added in an attempt to prevent rain from being blown under the shingle. Existing metal shingles are sometimes coated or painted to reflect heat and reduce the amount of heat transferred to the structure.

Currently available metal shingles do have disadvantages. Even with crimping, metal shingles suffer from the ability to provide a waterproof covering for a roof. Nails driven through a metal shingle do not self-seal the way nails in asphalt or wooden shingles self-seal. Nails in metal roofing allow for voids that allow water penetration.

In an attempt to create a waterproof covering, some available metal shingle interlock. While interlocking further decreases the chance of wind damage, interlocking increases the cost of the shingle and creates a look that is quite different from the traditional standing seam, asphalt, tile or wooden shingle look. Interlocking shingles are also time consuming to install and create difficulties in attempting to replace a shingle in a finished roof. Further, interlocking shingles typically require special trims.

It is an object of this invention to provide a shingle intended to simulate a traditional roof covering, such as wood shakes, asphalt shingles, metal standing seam, slate or tile, that provides a low cost, waterproof, lightweight, heat reflective, environmentally friendly and durable roofing system that is simple to install and maintain.

### BRIEF SUMMARY OF THE INVENTION

The present invention is useful for covering a structure surface, such as, but not limited to, the exterior of a building. The present invention is useful as a roofing material and or a siding material.

The present invention is a shingle and a method of using the shingle. The shingle is formed by stamping, extrusion, molding, pressing, and the like. The shingle comprises an upper surface comprising an attachment area and an exposed area. The attachment area is in a plane lower than a plane of the exposed area. A top attachment area extends longitudinally along a top side of the exposed area and a side attachment area extends horizontally along a side of the exposed area. In an embodiment, the side attachment area is located on the right edge of the shingle. In an embodiment, the exposed area comprises a plurality of planes. In an embodiment, at least the upper surface is formed. In an embodiment the upper surface is coined.

The exposed area comprises a coating and an inking. In an embodiment, the coating of the exposed area comprises a solar reflectance substance. In an embodiment, the coating and or the inking of the exposed area of the shingle is applied to mimic the look of a dimensional asphalt shingle, a wooden shingle, a tile shingle, a slate shingle and a standing seam panel. In an embodiment, the inking is an ink or a paint that us applied in lines and or stippled areas. In an embodiment, the basic material of the shingle is pre-coated with the coating. In an embodiment, the inking is applied by roll coating.

The shingle comprises an adhesive layer applied to a length of the top attachment area and the side attachment area adjacent to the exposed area. In an embodiment, the adhesive layer is a two-sided very high bond tape. In an embodiment, the very high bond tape is from about ¼ to about 2 inches wide.

In an embodiment, the side attachment area of the shingle is at about a ninety degree angle from the top attachment area. An edge formed between the planes of the exposed area and the attachment areas is a guide for aligning an additional shingle when the shingles are used in a system.

The shingle comprises a bottom surface opposite the upper surface. In an embodiment, the distance from the upper surface to the bottom surface is about 0.01 to about 0.025 inches. In an embodiment, the distance depth of the shingle is about 3/16 inches.

The shingles are attachable to each other and to a structure to provide a waterproof covering. When applied to a structure, the shingles overlap each other such that the adhesive layer of the side attachment area bonds to a bottom surface of a second shingle along a side edge opposite the side attachment area, and the adhesive layer of the top attachment area bonds to a bottom surface of a third shingle along a bottom edge opposite the top attachment area.

In an embodiment, the shingle is used to cover a roof, comprising the steps of: (1) positioning a first shingle at a bottom eave edge of a left side of a roof; (2) attaching the first shingle to the roof using at least one fastener; (3) exposing a release liner of the side attachment area adhesive layer; (4) aligning a second edge of the second shingle to an inner edge of the side attachment area adhesive layer and a chalk line of the roof; (5) pressing the bottom surface of the second shingle at the second edge against the side attachment area adhesive layer of the first shingle; (6) fastening the second shingle the roof in the same manner as the first shingle; (7) continuing to add additional shingles using steps 3-6 with successive shingles until a first course of shingles is attached to the roof; (8) trimming a last shingle in the first course to fit the roof; (9) exposing a release liner of the top attachment area adhesive layer of the first course first shingle; (10) aligning a second course initial shingle to the side of the roof and the first course; (11) pressing the bottom edge of the second course initial shingle to the top attachment area adhesive layer of a first course shingle; (12) fastening the second course initial shingle to the roof; (13) exposing a release liner of the top attachment area adhesive layer of a first course shingle and a release liner of the side attachment area adhesive layer of the second course initial shingle; (14) aligning a second course second shingle to the roof, the second course initial shingle, and the first course; (15) pressing (a) a bottom edge of the second course second shingle to the top attachment area adhesive layer of a first course shingle, and (b) a bottom surface at a second edge of the second shingle against the side attachment area adhesive layer of the second course initial shingle; (16) attaching the second course second shingle to the roof; (17) continuing to add additional shingles using steps 13-16 with successive shingles until a second course of shingles is attached to the roof; (18) trimming a last shingle in the second course to fit the roof; (19) continuing to add additional courses until the roof is covered with shingles; and (20) attaching any finish pieces using free-standing adhesive. In an embodiment, bottom sides may be primed prior to pressing to the adhesive layer. In an embodiment, the first shingle of any course may be trimmed to create a pattern. In an embodiment, aligning is assisted by an guide to aid in lining up a successive course shingle with an existing course.

In an embodiment the shingle is formed from metal. In an embodiment, the metal is about a 29 gauge steel. In an embodiment, the shingle is formed from a coil of steel and each shingle is stamped from the coil using a press. In an embodiment, the coil of steel is pre-coated with the coating. In an embodiment, the metal is coined and inked to mimic one of an asphalt shingle, a wooden shingle, a tile shingle, a slate shingle and a standing seam panel.

### BRIEF DESCRIPTION OF THE DRAWINGS

These and further features of the present invention will be apparent with reference to the following description and drawings, wherein:

FIG. 1 is a top view of an embodiment of the invention.

FIGS. 2a-2e are top view example embodiments of the invention.

FIG. 3 is a top view of an embodiment of the invention.

FIG. 4 is a top view of an embodiment of an embodiment of the invention assembled together showing the interconnection of multiple shingles in adjacent rows.

FIG. 5 is a side view of an embodiment of the invention.

FIG. 6 is a prospective view of an embodiment of the invention.

FIG. 7 is a top view of an embodiment of the invention.

FIG. 8 is a side view of an embodiment of the invention.

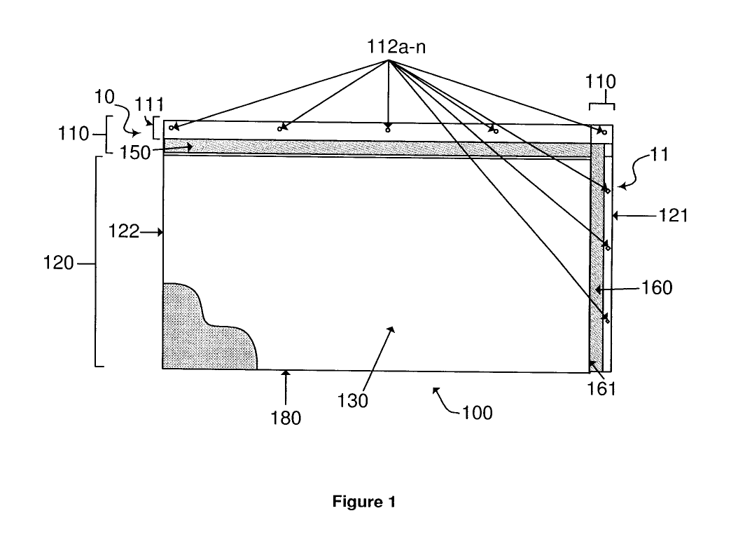

It should be understood that the appended drawings are not necessarily to scale, presenting a somewhat simplified representation of various preferred features illustrative of the basic principles of the invention. The specific design features of the metal shingle as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. For example, certain features may be enlarged for clarity or illustration. All references to direction and position, unless otherwise indicated, refer to the orientation of the metal shingle and system as illustrated in the drawings. In general, up or above generally refers to an upward direction within the plane of the paper in FIG. 1 and down or below generally refers to a downward direction within the plane of the paper in FIG. 1.

As used herein, “approximately” means within plus or minus 25% of the term it qualifies. The term “about” means between ½ and 2 times the term it qualifies.

All percentages, parts and ratios as used herein are by weight of the total composition, unless otherwise specified. All such weights as they pertain to listed ingredients are based on the active level and, therefore, do not include other products that may be included in commercially available materials, unless otherwise specified.

The compositions and methods of the present invention can comprise, consist of, or consist essentially of the essential elements and limitations of the invention described herein, as well as any additional or optional ingredients, components, or limitations described herein or otherwise useful in compositions and methods of the general type as described herein.

Numerical ranges as used herein are intended to include every number and subset of numbers contained within that range, whether specifically disclosed or not. Further, these numerical ranges should be construed as providing support for a claim directed to any number or subset of numbers in that range or to be limited to the exact conversion to a different measuring system, such, but not limited to, as between inches and millimeters.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

Terms such as “front,” “back,” “right,” “left,” “above”, “lower” and the like are words of convenience and are not to be construed as limiting.

### DETAILED DESCRIPTION OF THE INVENTION

Referring now to the drawings, FIG. 1 is an embodiment of the shingle of the present invention. The shingle is composed of any suitable material. In an embodiment, the shingle is composed of new or recycled metal, rubber, plastic, fiberglass or similar material. In an embodiment the shingle is made from a metal material. The remainder of this disclosure describes metal as a material, but any of the above-listed materials, or a new material suitable for the invention, may be substituted in the following detailed description.

Suitable materials are those that are durable, light weight, strong (such as those strong enough to resist dimpling from hail) and rust and corrosion resistant. Suitable metals include but are not limited to stainless steel, aluminum, copper, bronze, galvanized steel and metal alloys. In an embodiment, the shingle is formed from recycled materials. In an embodiment, the shingle comprises a second material. In an embodiment, the second material improves corrosion protection. In an embodiment, the second material is applied to the surface of a first material. In a metal shingle embodiment, the second metal is zinc, zinc-iron, aluminum and the like.

In a metal shingle embodiment, the shingle is composed of an aluminum-zinc alloy coated steel sheet. In an embodiment, the aluminum-zinc alloy coating is comprised of 55% aluminum, 43.5% zinc, and 1.5% silicon (suitable aluminum-zinc alloy coated steel sheets are sold as products marketed as Galvalume®, a registered trademark of BIEC International Inc., Z-NAL®, a registered trademark of Steelscape Inc., ZINCALUME®, a registered trademark of BHP Steel Pty Ltd., ZINTRO-ALUM™, a trademark of Industrias Monterrey S.A., and GALVAL™, a trademark of Galvak, S.A. de C.V.).

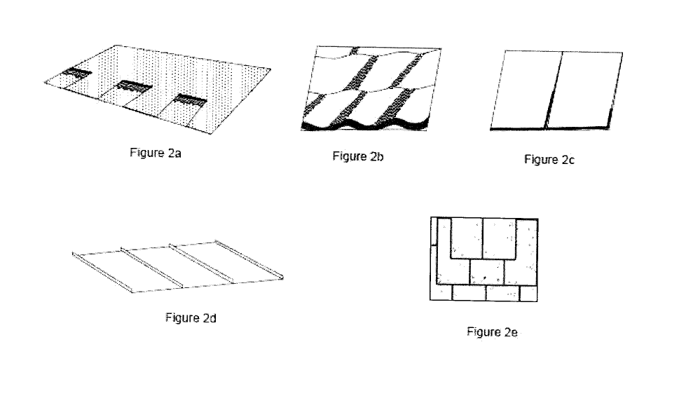

In an embodiment, the shingle is formed by die pressing. One or more dies are used to cut, shape and form the shingle to mimic the look of an architectural or dimensional shingle (including but not limited to a two or three tab shingle), a wooden shake shingle, a clay tile, a slate shingle, metal standing seam, and the like. To form the shingle, the base material is transferred into the press, aligned, formed, and unloaded. The base material may be an individual piece, or a strip from a coil. In an embodiment, the shingle is shaped by contour rollforming or warm forming. In an embodiment, a blank is conveyed over a male die, which engages the blank and push it into the desired plate. Upon compression, the blank assumes the intended shape without substantial changes in thickness. In an embodiment, a coining die forms a shingle having a flat surface on the back and raised features on the front. In an embodiment, the die embosses the blank so that surface on the back is the reverse shape of the front. In an embodiment, coining provides a shape which is modulated with different thicknesses. In an embodiment, the shingle is formed from a single stamp. In an embodiment, the shingle is formed by multiple stamping from the same press. In an embodiment, the shingle is formed from synchronized presses. FIG. 2 illustrates several embodiments of the shingle of the present invention, including a three tab shingle asphalt shingle (a two shingle may also be shaped), tile, wood shake, metal standing seam and slate. One skilled in the art would understand that other shapes could be obtained using different plates and different coining to obtain the present invention.

In an embodiment, the shingle is formed from a single blank. In an embodiment, the shingle is formed by cutting and or stamping the desired dimensions from a larger piece of material, such as a roll of rubber, a plastic or fiberglass sheet, a roll of sheet metal, and the like.

The shingle is generally rectangular in shape. In an embodiment, the shingle is about 1-2 times as long as it is wide. In an embodiment, the shingle is about 1.5 times as long as it is wide. In an embodiment, the shingle is about 12 inches wide. In an embodiment, the shingle is about 18 inches to about 20 inches wide. In an embodiment, the shingle is about 36 inches to about 40 inches wide. In an embodiment, the shingle has a length of about 36 inches. In an embodiment, the shingle has a length of about 40 inches. In an embodiment, the shingle is about 33.4 inches wide and about 22.6 inches long.

Referring to FIG. 1, the shingle comprises a generally flat upper surface 100 comprising an attachment area 110 and an exposed area 120. The exposed area 120 comprises a coating 130. The coating 130 is any suitable coating that provides color, reflectivity and or protection. In an embodiment, the coating 130 is a substance that does not absorb solar energy, thereby allowing the surface temperature to remain lower in sunlight. In an embodiment the coating is a thermoplastic polymer. In an embodiment, the coating is a silicon modified polyester.

In an embodiment, the coating 130 has a total solar reflectance (TSR) from about 0.15 to about 0.90. In an embodiment, the coating 130 has a TSR of at least about 0.70. In an embodiment, the coating 130 has a thermal emittance (TE) from about 0.1 to about 0.95. In an embodiment, the coating 130 has a TE of about 0.75. In an embodiment, the coating 130 meets the minimum standards of the Cool Metal Roofing Coalition.

In an embodiment, the coating 130 is an inorganic cool pigment that does not affect the color of the shingle. In an embodiment, the coating is a polyvinylidene fluoride (PF), such as Kynar®, commercially available from Arkema. PF is a stable, tough, abrasion resistant thermoplastic that is resistant to ultraviolet radiation, weathering, mold and harsh environments. PF is readily melt-processed for molding. Alternate pigments are available from Shepherd Color Co., Cincinnati, and Ferro Corp., Cleveland. Pigments may be infused into industrial coatings manufactured by Valspar, BASF Akzo Nobel, Oxonica, Dow Corning, and the like.

In an embodiment, the coating comprises a reflective pigment. Reflective pigments reflect away more of the sun's infrared energy than do traditional ceramic paint pigments, allowing the use of darker colors.

In an embodiment, the coating comprises a pigment that provides a color to the appearance of the shingle. Colors include but are not limited to gray (including driftwood), black, brown, and green and red. Other colors and custom colors are also useable for the present invention.

In an embodiment, the coating 130 is applied to the shingle by roll-coating. In an embodiment, the coating is applied to the material prior to stamping. In an embodiment, the coating 130 is applied to the metal at the coil stock stage. In an embodiment, the coating is applied by wet spraying or powder coating by techniques known in the art.

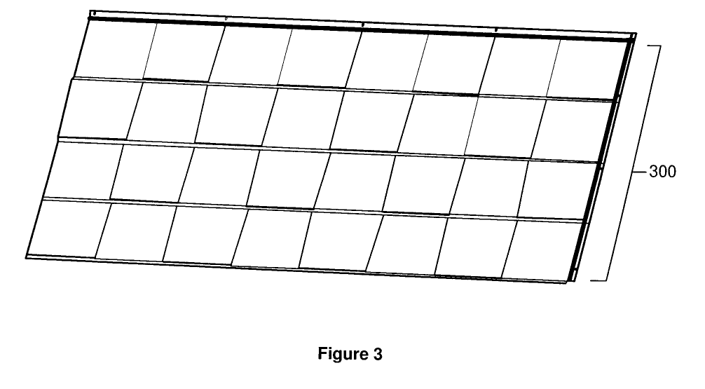

Referring to the embodiment depicted in FIG. 3, the coating comprises inking 300. Inking 300 is applied to provide the desired finish. In an embodiment, the inking 300 comprises lines and stippling to provide “shadow” areas. In an embodiment, the inking 300 is formulated to create the appearance of a layer by employing a combination of visually distinct shaded areas. As shown in the examples of FIG. 2, the inking is formulated to create the appearance of the traditional dimensional asphalt shingles, wooden shingles, metal, tile and or slate roofing. Inking is a textured finish in a variety of shadings and or colors that mimics a traditional shingle, such as individual tabs on an asphalt shingle through the application of pigment that appears as shading in the embodiment depicted in FIG. 3.

In an embodiment, the coating comprises a solar film, such as those available from United Solar Ovonics and the like. In an embodiment, the solar film is a silicon coating applied to the shingle from a peel and stick roll.

The attachment area 110 comprises a top attachment area 10 adjacent to the exposed area 120 and in a plane lower than a plane of the exposed area 120, such that a top edge 140 of the exposed area 120 forms a ridge. The top attachment area 10 comprises atop attachment area adhesive layer 150. The top attachment area adhesive layer 150 is applied adjacent to the top edge 140 for the length of the shingle. The top attachment area 10 comprises an attachment section 111. The attachment section 111 extends from the attachment area adhesive layer 150 to the top edge of the shingle. The attachment section 111 is generally flat and used for attaching the shingle to the structure. In an embodiment, the attachment section 111 comprises an embossed area 112a-n for placement of each fastener. In an embodiment, the embossed area 112a-n comprises slots, or holes for the fastener(s). In an embodiment, the attachment section 111 comprises both embossed area 112a-n and slots, or holes for the fastener(s).

The attachment area 110 comprises a side attachment area 11 adhesive layer 160. In an embodiment, the side attachment area adhesive layer 160 extends along an edge of a first side 121 of the exposed area 120.

In an embodiment, the shingle is attached to the structure by a fastener, such as a nail, screw, a staple, a rivet, an adhesive, or the like (not shown). In an embodiment, the shingle is attached to the structure by about 3 to 10 fasteners, preferably 8, placed outside the adhesive layers 150, 160 at the top attachment area and side attachment area.

In an embodiment, the top attachment area adhesive layer 150 and the side attachment area adhesive layer 160 are any permanent metal-to-metal bond that is not welding, rivets, bolts, screw or cementing. In an embodiment, the top attachment area adhesive layer 150 and the side attachment area adhesive layer 160 bond to painted metal without surface priming or abrading. Alternatively, the painted metal surface is primed before the top attachment area adhesive layer 150 and the side attachment area adhesive layer 160 are applied. The top attachment area adhesive layer 150 and the side attachment area adhesive layer 160 have superior tensile strength, adhesion properties and holding force which ensures consistent, reliable seals. The top attachment area adhesive layer 150 and the side attachment area adhesive layer 160 have high tack and high heat, shear, moisture, chemical and light resistance. The top attachment area adhesive layer 150 and the side attachment area adhesive layer 160 provide a uniform seal. The top attachment area adhesive layer 150 and the side attachment area adhesive layer 160 maintain adhesion at sub-zero temperatures, are stain-resistant and are resistant to mold and hardening with age. When a second shingle is attached to a first shingle using the top attachment area adhesive layer 150 or the side attachment area adhesive layer 160, the adhesive layer acts to dampens vibration and shock throughout the system. In an embodiment, the adhesive layer is any adhesive that bonds almost immediately, such as hot melt rubber, natural rubber, acrylic or silicone.

In an embodiment, the top attachment area adhesive layer 150 and the side attachment area adhesive layer 160 are each either a single sided or a two sided adhesive tape that is flexible, moldable, compressible and conformable. Adhesive tape distributes stress, allowing for a thinner adhesive layer that is light-weight. In an embodiment, the adhesive tape comprises an acrylic core. In an embodiment, the top attachment area adhesive layer 150 and the side attachment area adhesive layer 160 are each a very high bond (VHB) adhesive tape. In an embodiment, the top attachment area adhesive layer 150 and the side attachment area adhesive layer 160 are each a VHB adhesive tape commercially available from 3M. In an embodiment, the top attachment area adhesive layer 150 and the side attachment area adhesive layer 160 are each an ultra high bond double coated acrylic tape, such as is commercially available from JVCC, Gaska Tape Inc., or other brands.

In an embodiment where the top attachment area adhesive layer 150 and the side attachment area adhesive layer 160 are both a two sided-adhesive tape, a first side of the adhesive tape is exposed and applied to the shingle upon manufacture with the opposite side release liner intact. The release liner is peeled from the top attachment area adhesive layer 150 and the side attachment area adhesive layer 160 during installation of the system of the present invention to attach shingles to each other.

In an embodiment, the system of the present invention comprises finish and trim pieces (not shown) that have two-sided adhesive tape applied. In addition, free standing two-sided adhesive 155 may be cut, a first release liner removed and a first side of the tape applied to a shingle. In attaching the next shingle, the second release liner is removed and the additional shingle (or a part of a shingle) or a trim or finish piece is attached to the first shingle.

In an embodiment, the top attachment area adhesive layer 150 and the side attachment area adhesive layer 160 is about ¼ inch to about 2 inches wide. In an embodiment, the adhesive layer is approximately 1 inch wide. In an embodiment, the attachment area adhesive layer 150 is ½ wide. In an embodiment, the side attachment area adhesive layer 160 is about ¼ inch wide. In an embodiment, the adhesive layer is from about 1/32 to about 3/32 inch thick.

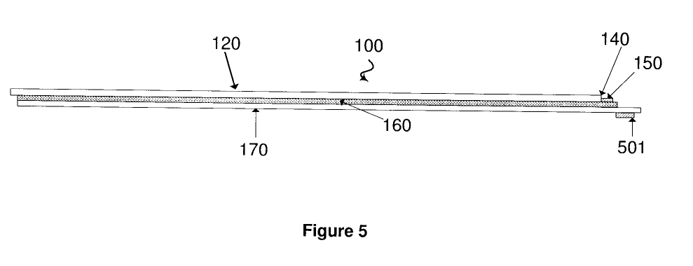

Referring to FIG. 5, the shingle has a bottom surface 170 opposite the upper surface 100. The thickness of the shingle varies based on the material used, the intended application, and the environment. In an embodiment where the shingle is metal, the shingle is about 0.0139 inch thick (29 gauge sheet metal). In an embodiment where the shingle is metal, the shingle is about 0.0196 inch thick (26 gauge sheet metal). In an embodiment where the shingle is metal, the shingle is about 0.0247 inch thick (24 gauge sheet metal). In an embodiment, the bottom surface 170 opposite the attachment area 110 comprises an attachment means 501. The attachment means 501 is used to attach the shingle to the building surface, whether that surface is wood, felt, plastic or an existing shingle. In an embodiment, the attachment means 501 is a glue and or an adhesive tape.

As shown in FIG. 5, the shingle comprises a guide 500 proximate to the bottom edge 180. The guide 500 is used to align the shingle rows when assembling. The guide 500 is any structure or indicator that provides fast and easy orientation of the next shingle. In an embodiment, the guide is an embossed notch.

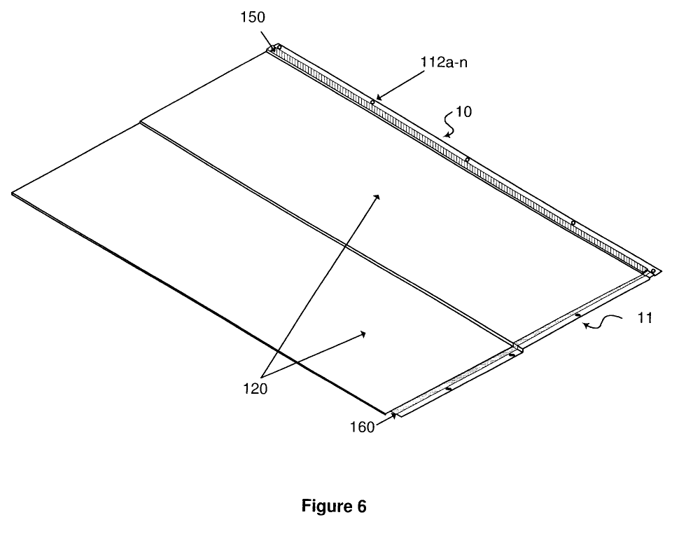

An embodiment having two elevations or rows of exposed area is depicted in FIG. 6.

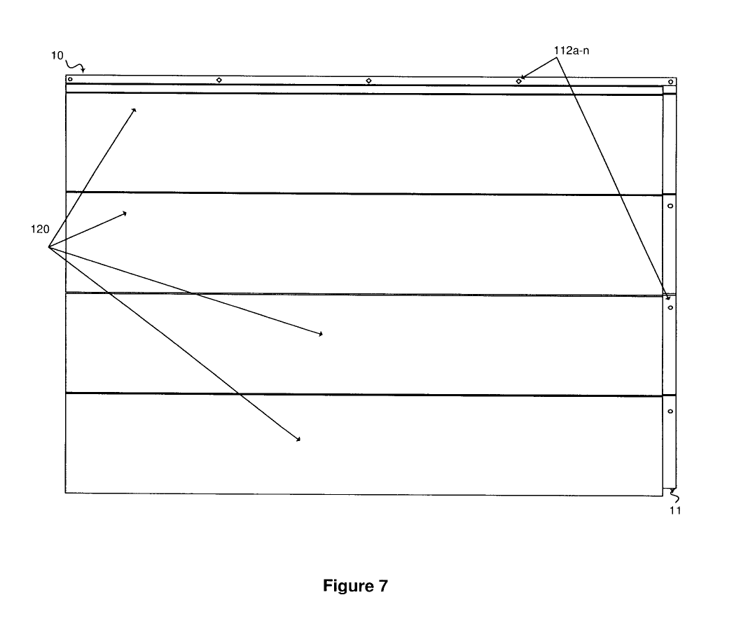

An embodiment having four elevations or rows of exposed area is depicted in FIG. 7 (although any number of rows is possible). FIG. 7 shows the invention without the adhesive layer. The invention is embossed so that the bottom surface 170 is the reverse shape of the upper surface 100. In an embodiment, the embossment provides ¼ inch change in the depth of the shingle.

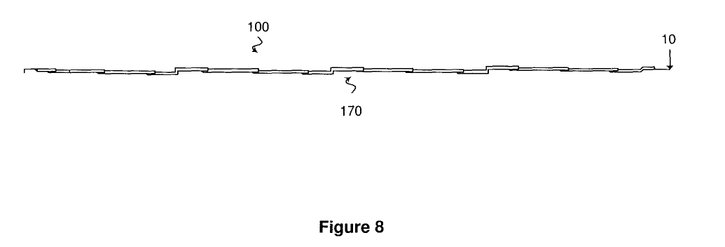

FIG. 8 depicts the embossment of an embodiment having four elevations or rows in a side view.

In an embodiment, the invention comprises a repair kit. The repair kit comprises at least one shingle formed from the same material as the existing shingle, two-sided adhesive tape, at least one fastener, and paint.

Method

The method of making a shingle of the present invention will now be described.

An upper surface of a material, such as rubber, plastic fiberglass or metal is coated with a coating. In an embodiment, the coating is a solar reflective coating. In an embodiment, the bottom surface is coated to provide corrosion resistance.

Prior to forming, inking is applied so that the finished shingle mimics a plurality of asphalt, wooden, tile, or slate shingles or several panels of metal standing seam roofing. An adhesive layer is applied to a portion of the upper surface comprising an attachment area. The attachment area receiving the adhesive layer may be primed prior to the adhesive layer being applied to the primed areas. The shingle is stamped and cut.

Metal Shingle Example

In an embodiment where the material is metal, raw steel is coil coated with a silicon modified polyester. The coating is applied to the upper surface. The coil stock is fed to an uncoiler and aligned and fed into a press for stamping. Inking is applied to mimic the appearance of one or more asphalt, wooden, slate or clay shingle or a metal standing seam panel(s). An adhesive layer is applied to an attachment area portion of the coated upper surface, which may be primed prior to the application of the adhesive layer. In an embodiment, the adhesive layer is applied without priming. In an embodiment, the adhesive layer is applied to the primed area. In an embodiment using VHB two-sided adhesive tape for the adhesive layer, a first side of the tape is exposed and applied to a portion of the attachment area with the other side release liner intact. The adhesive layer is applied adjacent to the exposed area near the top edge 140 at a distance from the top of the shingle for the length of the shingle and along the first side 121 of the shingle at the side attachment area 11 adjacent to the exposed area. The shingle is stamped to create the top edge. In an embodiment, stamping also creates impressions and or embossments in the shingle that assist in mimicking the look of asphalt, wooden, tile, or slate shingles or metal standing seam panels. The shingle is cut and readied for application.

Method of Using the Shingle

The method of applying the shingles to the structure will now be described. The example used is a roof, however, an surface of the structure may be covered with the shingle. As with typical roofing, trim at the eaves, gables and valleys are initially installed.

Using an example where the shingle is generally rectangular in shape, a first shingle is positioned and attached to the roof using at least one fastener starting at the bottom cave at the left side of the roof. In an embodiment where the shingle is about 30 inches wide and about 23 inches long, about 3-10 fasteners, preferably 5, are used to attach the shingle to the roof at a top attachment area section 10, and about 1-5 fasteners, preferably 3, are used to attach the shingle to the roof at a side attachment area section 11. In an embodiment, the fasteners attach the shingle to the roof at least one embossed area 112a-n.

The release liner of the side attachment area adhesive layer 160 is removed and a second shingle is aligned by matching a second edge 122 to an inner edge 161 of the side attachment area adhesive layer 160 and a chalk line of the roof. Primer may be applied along the edges of the side of the shingle that will bond to the side attachment adhesive layer of the first applied shingle. The bottom surface 170 of the second shingle at the second edge 122 is pressed against the side attachment area adhesive layer 160 to bond the second shingle to the side attachment area adhesive layer 160 of the first shingle and the second shingle is fastened to the roof in the same manner as the first shingle. Additional shingles are attached in a similar fashion until a first course of shingles is attached to the structure. The last shingle in the row is cut to fit the roof. In an embodiment using a metal shingle, metal snips or a power saw or shears are used to trim the shingle.

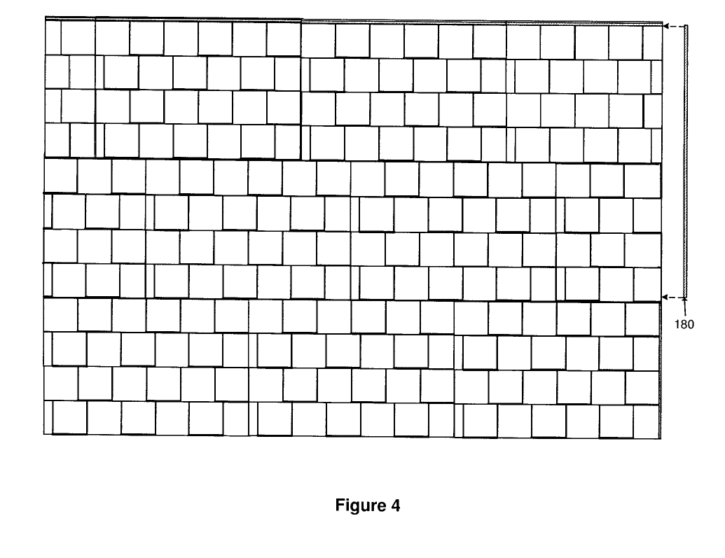

Patterns, such as centered, diagonal or random roof patterns are achieved by adjusting the length of the shingle that begins each course. In a diagonal pattern embodiment depicted in FIG. 4, the first shingle of the second course is trimmed to the desired width from the left side of the shingle so that the side attachment area adhesive layer 160 remains on the portion to be applied to the roof. The release liner of the first shingle of the first course of the attachment area adhesive layer 150 is removed. In an embodiment, primer is applied along the edges of the side of the shingle that will bond to the side attachment area adhesive layer of the first shingle. The trimmed second course shingle is vertically aligned to the side of the roof and horizontally aligned to the first course by placing the guide 500 at the bottom edge 180 of the trimmed second course shingle in contact with the top edge 140 of the first shingle of the first course. The bottom surface 170 of the trimmed second course shingle is pressed for bonding and attached to the roof with at least one fastener. The second course shingles are applied in a like manner. The discarded portion of a previously trimmed shingle may be used to finish the end of the second course (or any remaining courses). Free standing adhesive layer 155 is prepped and applied to the course end trimmed shingle in generally alignment with the side attachment area adhesive layer 160 of the shingles in the course below. The first shingle of the third course is not trimmed. The process is repeated to top of the roof. In an embodiment, no first or initial shingle of any course is trimmed. The present invention accommodates standard ridge vents. In an embodiment, the present invention comprises a ridge cap.

Finish pieces are added to the end shingles. Finish pieces are of any length as long as the pieces are able to be transported to the roof. In an embodiment the finish pieces are 10′ lengths. In an embodiment, the finish pieces are j-channels, ridge caps and the like. Primer is optionally applied at the points of the shingle that will bond to the exposed adhesive layer of the finish pieces. Finish pieces may have an existing adhesive layer or a free standing adhesive layer 155 may be cut for use in installation. The roofing system may include finish pieces, such as a cap and those for providing ventilation for the roofing system and or the structure.

In a method of using the repair kit, a damaged shingle is removed by cutting or alternatively, left in place and covered. A shingle of the present invention matching the installed shingles is bonded to the existing shingles using the two-sided adhesive tape and or at least one fastener. The coating and or inking may be reapplied to blend with the existing shingles.

The shingles of the present invention offer a long life-span, with little or no real maintenance at all. They are extremely weather resistant and offer excellent performance in high winds, hail and rain. The metal shingles of the present invention are recyclable.

One skilled in the art will understand that the description of the present invention herein is presented for purposes of illustration and that the design of the present invention should not be restricted to only one configuration or purpose, but rather may be of any configuration or purpose which essentially accomplishes the same effect.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated.

It is therefore to be understood that within the scope of the appended claims, the invention may be practiced otherwise than as specifically described herein.

What is claimed is:

1. A metal shingle comprising:
(a) an upper surface comprising an attachment area and an exposed area, said upper surface coined, said exposed area comprising a coating and an inking, said attachment area (i) in a plane lower than a plane of the exposed area, and (ii) having a top attachment area extending longitudinally along a top side of the exposed area and a side attachment area extending horizontally along a side of the exposed area;
(b) a bottom surface opposite the upper surface; and
(c) an adhesive layer applied to a length of the top attachment area and a length of the side attachment area, each adjacent to the exposed area, said side attachment area at about a ninety degree angle from the top attachment area.

2. The metal shingle of claim 1 wherein an application of at least one of the coating and the inking mimics the look of one of the members selected from the group: at least one dimensional asphalt shingle, at least one wooden shingle, at least one tile shingle, at least one slate shingle and at least one standing seam panel.

3. The metal shingle of claim 2 wherein the exposed area comprises a plurality of planes.

4. The metal shingle of claim 1 wherein an edge formed between the planes of the exposed area and the attachment area is a guide for aligning an additional shingle when the shingles are used in a system.

5. The metal shingle of claim 1 wherein the adhesive layer is a two-sided very high bond tape.

6. The metal shingle of claim 5 wherein the very high bond tape is from about ¼ to about 2 inches wide.

7. The metal shingle of claim 1 wherein the coating comprises a solar reflectance substance.

8. The metal shingle of claim 1 wherein the distance from the upper surface to the bottom surface is about 0.01 to about 0.025 inches.

9. The metal shingle of claim 1 wherein the metal is about a 29 gauge steel.

10. The metal shingle of claim 1 wherein the depth of the shingle is about 3/16 inches.

11. A system to provide a waterproof covering to a structure comprising a plurality of the metal shingles of claim 1 wherein the shingles overlap each other such that the adhesive layer of the first side of the exposed area bonds to a bottom surface of a second shingle along a side edge and the adhesive layer the attachment area bonds to a bottom surface of a third shingle along a bottom edge.

12. A method of making the shingle of claim 1.

13. A method of making the shingle of claim 5.

14. The method of claim 12 wherein the inking is applied by roll coating.

15. A method of roofing using the shingle of claim 1 comprising the steps of:
(1) positioning a first shingle at a bottom eave edge of a left side of a roof;
(2) attaching the first shingle to the roof using at least one fastener;
(3) aligning a second edge of the second shingle to an inner edge of the side attachment area adhesive layer and a chalk line of the roof;
(4) pressing the bottom surface of the second shingle at the second edge against the side attachment area adhesive layer of the first shingle;
(5) fastening the second shingle the roof in the same manner as the first shingle;
(6) continuing to add additional shingles using steps 3-6 with successive shingles until a first course of shingles is attached to the roof;
(7) aligning a second course initial shingle to the side of the roof and the first course;
(8) fastening the second course initial shingle to the roof;
(9) pressing (a) the bottom edge of the second course second shingle to the attachment area adhesive layer of the first shingle and (b) the bottom surface at the second edge of the second course second shingle to the side attachment area adhesive layer of the initial shingle;
(10) attaching the second course second shingle to the roof;
(11) continuing to add additional shingles using steps 7-10 with successive shingles until a second course of shingles is attached to the roof;
(12) continuing to add additional courses until the roof is covered with shingles; and
(13) attaching any finish pieces using free-standing adhesive.

16. A method of roofing using the shingle of claim 5 comprising the steps of:
(1) positioning a first shingle at a bottom eave edge of a left side of a roof;
(2) attaching the first shingle to the roof using at least one fastener;
(3) exposing the release liner of the side attachment area adhesive layer;
(4) aligning a second edge of the second shingle to an inner edge of the side attachment area adhesive layer and a chalk line of the roof;
(5) pressing the bottom surface of the second shingle at the second edge against the side attachment area adhesive layer of the first shingle;
(6) fastening the second shingle the roof in the same manner as the first shingle;
(7) continuing to add additional shingles using steps 3-6 with successive shingles until a first course of shingles is attached to the roof;
(9) aligning a second course initial shingle to the side of the roof and the first course;
(10) fastening the second course initial shingle to the roof;
(11) exposing a release liner of the top attachment area adhesive layer of at least one first course shingle;
(12) exposing a release liner of the side attachment area adhesive layer of the second course initial shingle;
(13) pressing the (a) bottom edge of the second course second shingle to the attachment area adhesive layer of the first shingle and (b) the bottom surface at the second edge of the second course second shingle to the side attachment area adhesive layer of the initial shingle;
(14) attaching the second course second shingle to the roof;
(15) continuing to add additional shingles using steps 9-14 with successive shingles until a second course of shingles is attached to the roof;
(16) continuing to add additional courses until the roof is covered with shingles; and
(17) attaching any finish pieces using free-standing adhesive.

17. The method roofing of claim 15 further comprising the step of trimming a last shingle in any course to fit the roof.

18. The method roofing of claim 15 further comprising the step of adjusting the length of any course initial shingle.

19. The method roofing of claim 15 further comprising the step of priming a surface of the shingle prior to adding an adhesive layer.

20. The method roofing of claim 15 further comprising the step of priming a surface of the shingle prior to pressing to the adhesive layer of another shingle.
